(19) United States
(12) Patent Application Publication
(10) Pub. No.: US 2012/0252378 A1
(43) Pub. Date: Oct. 4, 2012

(54) ELECTRONIC DEVICE, ELECTRONIC DEVICE CONTROLLING METHOD AND COMPUTER PROGRAM PRODUCT THEREOF

(75) Inventor: Masao TESHIMA, Kunitachi-shi (JP)

(73) Assignee: Kabushiki Kaisha Toshiba, Tokyo (JP)

(21) Appl. No.: 13/337,694

(22) Filed: Dec. 27, 2011

(30) Foreign Application Priority Data
Mar. 31, 2011 (JP) 2011-080772

(51) Int. Cl. H04B 1/38

(52) U.S. Cl. 455/90.1

(57) ABSTRACT

An electronic device includes a transmitter configured to transmit a wireless signal; a receiver configured to receive a wireless signal in parallel with the transmission of the transmitter; a detector configured to detect whether a human body is close to the electronic device based on a reception level of the wireless signal received by the receiver.

### CROSS-REFERENCE TO RELATED APPLICATIONS

This application is based upon and claims the benefit of priority from Japanese Patent Application No. 2011-080772, filed Mar. 31, 2011, the entire contents of which are incorporated herein by reference.

### FIELD

Embodiments described herein relate generally to an electronic device, an electronic device controlling method, and a computer program product thereof.

### BACKGROUND

Conventionally, in an electronic device such as a mobile telephone terminal, and a tablet type personal computer including a communication function, especially, in a portable electronic device, in consideration of influence on a human body from local electromagnetic field generated near a transmission antenna when a user communicates by using the electronic device in a state that the electronic device is in close contact with the human body, a tolerance of the specific absorption rate (SAR), which measures the amount of electromagnetic field locally absorbed by the human body is defined, and the electronic device needs to be designed so that the electronic device complies with the tolerance of the SAR. For this reason, a technique has been provided in which whether a human body is close to an electronic device is determined to control transmission power from the electronic device.

In a conventional configuration, a function configuration to determine whether a human body is close to an electronic device is provided separately from an original or basic communication function configuration. Therefore, the configuration of the device is complicated, the cost of the device is high, and the control of the device is complicated.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of an electronic device according to an embodiment;

FIG. 2 is an exemplary schematic block diagram of a wireless communication function module of the electronic device in the embodiment;

FIG. 3 is an exemplary flowchart of processing in the embodiment;

FIG. 4 is an exemplary diagram for explaining a reception signal level in the embodiment;

FIG. 5A is an exemplary diagram for explaining a state in the electronic device is not close to a human body in the embodiment;

FIG. 5B is an exemplary diagram for explaining a state in the electronic device is close to a human body in the embodiment; and

FIG. 6 is an exemplary timing chart of a transmission operation and a reception operation in the embodiment.

### DETAILED DESCRIPTION

In general, according to one embodiment, an electronic device comprises: a transmitter, a receiver, and a detector. The transmitter is configured to transmit a wireless signal. The receiver is configured to receive a wireless signal in parallel with the transmission of the transmitter. The detector is configured to detect whether a human body is close to the electronic device based on a reception level of the wireless signal received by the receiver.

An electronic device and an electronic device controlling method according to an embodiment will now be explained in detail with reference to the drawings.

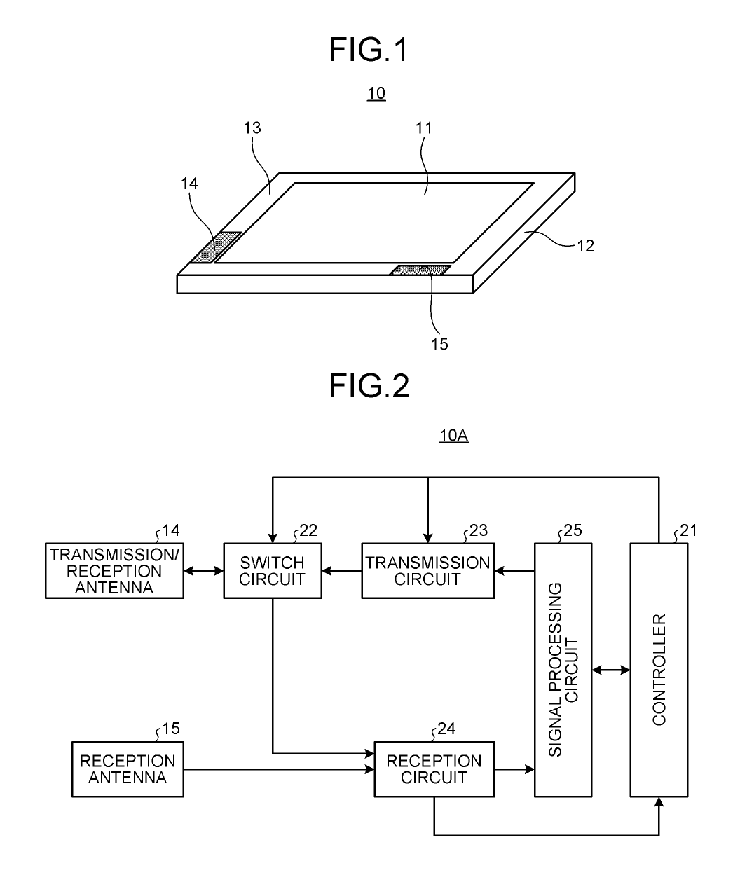

FIG. 1 is an appearance perspective view of an electronic device according to the embodiment. As illustrated in FIG. 1, an electronic device 10 is a tablet type device, and comprises a case 12 containing a touch panel display 11. A transmission/reception antenna 14 which transmits and receives a wireless radio signal with a predetermined frequency and a reception antenna 15 which receives the wireless radio signal with the predetermined frequency, which constitute a wireless communication function module described later, are included inside predetermined positions of a bezel 13 of the case 12.

FIG. 2 is a schematic block diagram of the wireless communication function module of the electronic device in the embodiment. A wireless communication function module 10A of the electronic device 10 comprises a controller 21 which controls the entire wireless communication function module 10A, the transmission/reception antenna 14, a switch circuit 22 which switches between a transmission and a reception of the transmission/reception antenna 14, a transmission circuit 23 which modulates an input transmission signal to transmit as a transmission radio signal through the transmission/reception antenna 14, the reception antenna 15, a reception circuit 24 which demodulates the wireless radio signal received through the transmission/reception antenna 14 or the reception antenna 15 to output as a reception signal, and a signal processing circuit 25 which performs signal processing under the control of the controller 21 to transmit the transmission signal to the transmission circuit 23 and performs processing on the reception signal received from the reception circuit 24 to output as reception data to the controller 21.

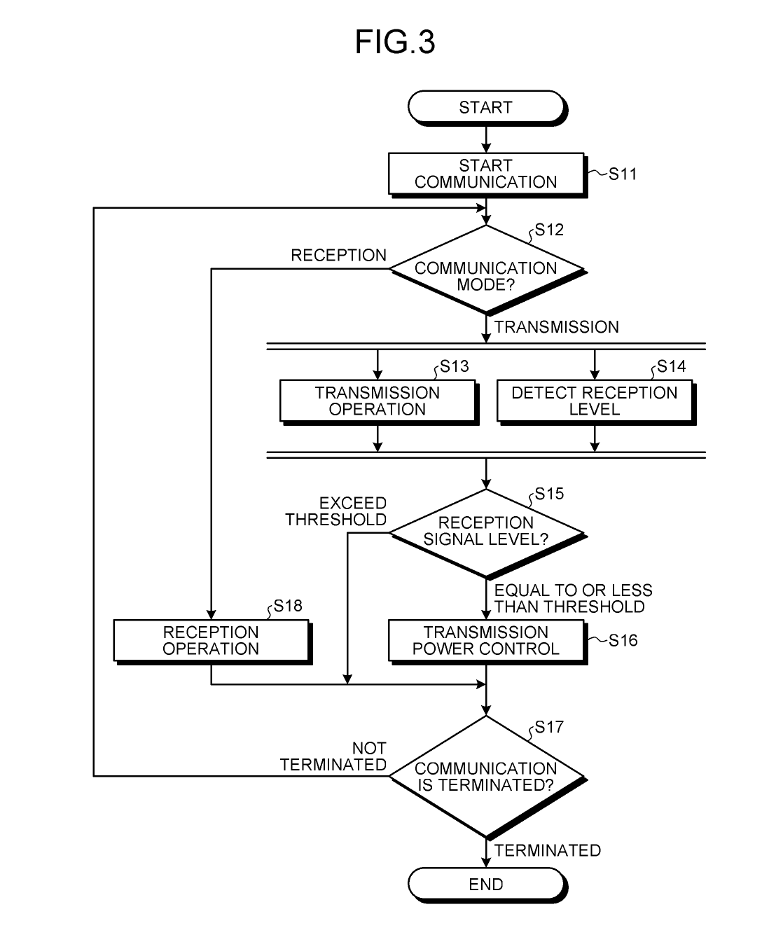

Operations of the embodiment will be explained below. FIG. 3 is a flowchart of operations of the embodiment. When the controller 21 starts communication (S11), the controller 21 determines whether a communication mode is a transmission or a reception (S12).

If the communication mode is the transmission as a result of the determination at S12 and the controller 21 performs the transmission with respect to an external communication device (transmission at S12), the controller 21 switches the switch circuit 22 to the transmission side (the transmission circuit 23 side). The controller 21 controls the signal processing circuit 25 to output the transmission signal to the transmission circuit 23. The transmission circuit 23 modulates the input transmission signal to output it to the transmission/reception antenna 14. When the transmission/reception antenna 14 receives the modulated transmission signal, the transmission/reception antenna 14 converts the modulated transmission signal to a radio wave to radiate and transmit it to the external communication device (S13).

In parallel with this, the controller 21, in synchronization with the start of the transmission operation, controls the reception antenna 15 to receive the transmission radio signal (the wireless radio signal) transmitted from the transmission/reception antenna 14 and to output a reception signal level signal to the reception circuit 24 (S14). Prior to a completion of the transmission operation, the reception operation is stopped.

Here, the reception operation is started in synchronization with the start of the transmission operation, and the reception operation is stopped prior to the completion of the transmission operation. This is because the reception operation is performed surely in a state that the transmission operation is performed (a transmission operation intermediate term) to perform a transmission output control.

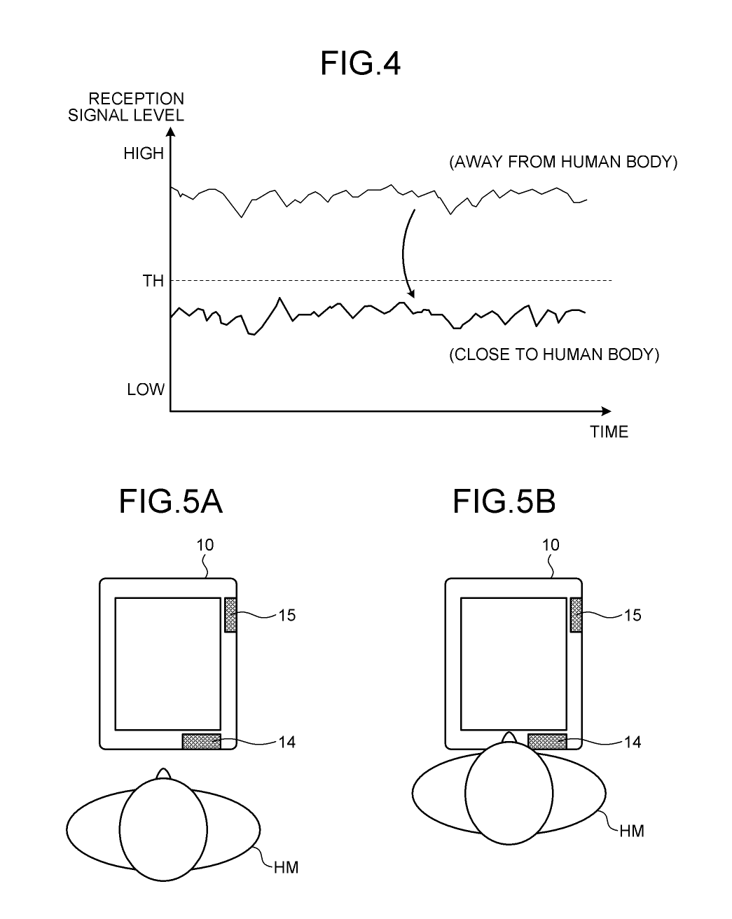

FIG. 4 is a graph of the reception signal level in the embodiment. FIG. 5A is a schematic top view of a positional relationship between a human body and the electronic device, in which the human body is away from the electronic device in the embodiment. FIG. 5B is another schematic top view of a positional relationship between the human body and the electronic device, in which the human body is close to the electronic device in the embodiment. As illustrated in FIG. 5A, when a human body of a user HM is away from the electronic device 10, as illustrated in an upper portion of FIG. 4, the transmission radio signal irradiated from the transmission/reception antenna 14 is not so absorbed by the human body HM because the transmission/reception antenna 14 is located away from the human body HM, or the reception signal level detected by the reception circuit 24 through the reception antenna 15 is high because the change in the property of the transmission/reception antenna 14 caused by the human body HM is small.

On the other hand, as illustrated in FIG. 5B, when the human body HM is close to the electronic device 10, as illustrated in a lower portion of FIG. 4, the transmission radio signal irradiated from the transmission/reception antenna 14 is so absorbed by the human body HM and is attenuated because the transmission/reception antenna 14 is located close to the human body HM, or the reception signal level detected by the reception circuit 24 through the reception antenna 15 is low because the change in the property of the transmission/reception antenna 14 caused by the human body HM is large.

The controller 21 determines whether the reception signal level is equal to or less than a threshold TH of the reception signal level corresponding to an upper limit of a predetermined tolerance of the specific absorption rate (SAR), which measures the amount of electromagnetic field locally absorbed by the human body (S15). As a result of the determination at S15, if the reception signal level is equal to or less than the threshold TH, that is, the amount of the transmission radio signal irradiated from the transmission/reception antenna 14 absorbed by the human body exceeds the tolerance of the SAR (equal to or less than the threshold at S15), the controller 21 determines that the human body HM is close to the electronic device 10, and performs the transmission output control of the transmission circuit 23 so that the transmission circuit 23 reduces transmission power from the transmission/reception antenna 14 (S16), and the process proceeds to S17.

In association with the transmission output control, if the transmission power from the transmission/reception antenna 14 is reduced, the reception signal level also decreases. Therefore, the controller 21 performs control to reduce the value of the threshold TH of the reception signal level. The above mentioned state in which the value of the threshold TH and the level of the transmission output are reduced is reset by the controller 21 when the reception signal level exceeding the threshold TH which is reduced is detected, because the controller 21 determines that the human body HM is not close to the electronic device 10. That is, at this time, the value of the threshold TH and the level of the transmission output are reset to the initial states, respectively.

As a result of the determination at S15, if the reception signal level exceeds the threshold TH, that is, the amount of the transmission radio signal irradiated from the transmission/reception antenna 14 absorbed by the human body is equal to or less than the tolerance of the SAR (exceed the threshold at S15), the controller 21 determines whether the communication is terminated (S17). As a result of the determination at S17, if the communication is not terminated (not terminated at S17), the controller 21 performs S12, again. As a result of the determination at S17, if the communication is terminated (terminated at S17), the controller 21 ends the processing.

On the other hand, as a result of the determination at S12, if the communication mode is the reception and the controller 21 performs the reception with respect to an external communication device (reception at S12), the controller 21 switches the switch circuit 22 to the reception side (the reception circuit 24 side). Then, the reception operation is performed as follows (S18). The reception circuit 24 performs a diversity reception by using the transmission/reception antenna 14 and the reception antenna 15. The reception circuit 24 demodulates the wireless radio signal input through transmission/reception antenna 14 or the reception antenna 15 to output to the signal processing circuit 25 as the reception signal. The signal processing circuit 25 performs processing on the reception signal input from the reception circuit 24 under control of the controller 21 to output to the controller 21 as the reception data.

If the reception operation is terminated, the controller 21 determines whether the communication is terminated (S17). As a result of the determination at S17, if the communication is not terminated (not terminated at S17), the controller 21 performs S12, again. As a result of the determination at S17, if the communication is terminated (terminated at S17), the controller 21 ends the processing.

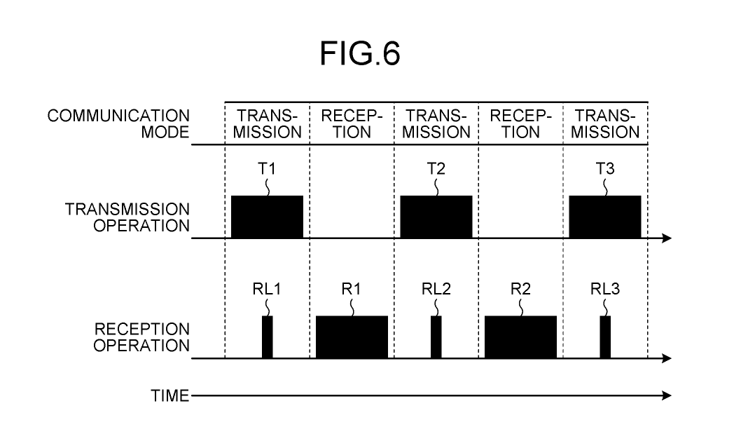

FIG. 6 is a timing chart of the transmission operation and the reception operation in the embodiment. As illustrated in FIG. 6, when the transmission operation and the reception operation are performed in accordance with the above mentioned procedure, whether the human body HM is close to the electronic device 10 is determined at reception operation periods for detecting the reception level RL1, RL2, and RL3. The reception operation periods for detecting the reception level RL1, RL2, and RL3 are synchronized with transmission operation periods T1, T2, and T3 for communicating through the transmission/reception antenna 14 with an external device. In this embodiment, the reception operation periods for detecting the reception level RL1, RL2, and RL3 at which whether the human body HM is close to the electronic device 10 is determined are in the middle of the transmission operation periods T1, T2, and T3 for communicating through the transmission/reception antenna 14 with an external device. The reception operation for communicating with the external device is performed by using the transmission/reception antenna 14 and the reception antenna 15 at diversity reception operation periods R1, R2. The diversity reception operation periods R1, R2 are different from the transmission operation periods T1, T2, and T3, and are interposed between the transmission operation periods T1, T2, and T3, and are synchronized with the transmission operation periods T1, T2, and T3. In this manner, the transmission power control can be performed during the original transmission operation periods T1, T2, and T3. Therefore, it is possible to substantially improve communication efficiency. According to this embodiment, the electronic device can be provided which performs operations complying with the tolerance of the SAR, which measures the amount of electromagnetic field locally absorbed by the human body without substantially lowering communication efficiency.

Each of the computer programs executed in the electronic device in the embodiment is pre-installed on ROMs and the like, but it is not limited to this. As an installable file, or an executable file, each of the computer programs executed in the electronic device can be stored in a computer readable recording medium such as a Compact Disc (CD), a Compact Disc-Read Only Memory (CD-ROM), a flexible disc (FD), a Compact Disc Recordable (CD-R), a Digital Versatile Disc (DVD) to be distributed.

Each of the computer programs executed in the electronic device in the embodiment can be provided by storing each of the computer programs executed in the electronic device into a computer connected to a network such as the Internet and downloading each of the computer programs executed in the electronic device from the computer via the network. Each of the computer programs executed in the electronic device can be provided or distributed via a network such as the Internet.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a transmitter configured to transmit a wireless signal;
a receiver configured to receive a wireless signal in parallel with transmission of the transmitter; and
a detector configured to detect whether a human body is close to the electronic device based on a reception level of the wireless signal received by the receiver.

2. The electronic device of claim 1, wherein the detector is configured to change a threshold of the reception level in accordance with a transmission output level of the wireless signal transmitted from the transmitter.

3. The electronic device of claim 1, wherein
when detecting that the human body is close to the electronic device, the detector is configured to reduce a transmission output level of the wireless signal transmitted from the transmitter and change a threshold of the reception level, and
when changing the threshold of the reception level, if the reception level is detected to exceed the changed threshold of the reception level, the detector is configured to reset the transmission output level and the threshold of the reception level to initial states.

4. The electronic device of claim 1, wherein the detector is configured to detect whether the human body is close to the electronic device based on the reception level of the wireless signal received by the receiver while the transmitter transmits the wireless signal for communication.

5. The electronic device of claim 1, wherein the receiver is configured to start receiving the wireless signal in synchronization with a transmission operation of the transmitter.

6. The electronic device of claim 5, wherein the receiver is configured to perform a reception operation to detect whether the human body is close to the electronic device during a transmission operation period in which the transmitter transmits the wireless signal for communication.

7. An electronic device comprising:
a first antenna configured to transmit or receive a wireless signal;
a switch configured to selectively connect the first antenna to a transmitter or a receiver; and
a second antenna configured to receive a wireless signal, wherein
the switch is configured to connect the first antenna to the transmitter when the receiver receives a wireless signal in parallel with transmission processing of the transmitter, and
the receiver is configured to perform a reception operation through the second antenna when the receiver receives the wireless signal in parallel with the transmission processing of the transmitter.

8. An electronic device controlling method performed in an electronic device comprising a transmitter configured to transmit a wireless signal, and a receiver configured to receive a wireless signal in parallel with transmission of the transmitter, the method comprising:
with the receiver, receiving a wireless signal while the transmitter transmits a wireless signal for communication with an external device; and
detecting whether a human body is close to the electronic device based on a reception level of the wireless signal received by the receiver.

9. A computer program product having a non-transitory computer readable medium including programmed instructions, wherein the instructions, when executed by a computer, cause the computer to:
receive, with a receiver, a wireless signal while a transmitter transmits a wireless signal for communication with an external device; and
detect whether a human body is close to an electronic device based on a reception level of the wireless signal received by the receiver.
